(19) United States
(12) Patent Application Publication
(10) Pub. No.: US 2008/0191008 A1
(43) Pub. Date: Aug. 14, 2008

(54) METHOD AND SYSTEM FOR PROVIDING REMOTE FINANCIAL SERVICES

(76) Inventors: Mirko Manfredi, Honolulu, HI (US); Mia Kim, Honolulu, HI (US)

Correspondence Address: STRATEGIC PATENT GROUP, P.C., P.O. BOX 1329, MOUNTAIN VIEW, CA, 94042, US

(21) Appl. No.: 12/030,021

(22) Filed: Feb. 12, 2008

Related U.S. Application Data
(60) Provisional application No. 60/912,326, filed on Apr. 17, 2007.
(60) Provisional application No. 60/889,530, filed on Feb. 12, 2007.

(51) Int. Cl. G06Q 40/00

(52) U.S. Cl. 235/379

(57) ABSTRACT

A method and system for providing remote financial services are described. The method and system include receiving a request for financial transaction(s) from a customer through a kiosk at a remote location. The kiosk includes a first camera and a display, and is coupled with a call center at a location physically distinct from the remote location. The call center includes a second camera for an individual. The method and system also include displaying image(s) of the individual on the display of the kiosk to provide a virtual attendant who assists the customer with the financial transaction(s). Data is transferred from the call center to the kiosk and displayed on the kiosk. Other data is transferred from the kiosk to the call center and displayed to the individual. The method and system also include dispensing funds from the kiosk if the financial transaction(s) are successful.

### CROSS-REFERENCE TO RELATED APPLICATIONS

This application claims the benefit of provisional Patent Application Ser. No. 60/889,530, entitled “Method and System for Providing a Variety of Financial Services” filed Feb. 12, 2007, assigned to the assignee of the present application. This application also claims the benefit of provisional Patent Application Ser. No. 60/912,326 entitled “Method and System for Providing Remote Financial Services via a Web-cam” filed Apr. 17, 2007 and assigned to the assignee of the presented application. Both applications are incorporated herein by reference.

### BACKGROUND OF THE INVENTION

Consumers use a variety of financial transactions in their daily lives. At least some of these transactions may take place remote from traditional financial institutions such as banks and savings and loans. For example, some consumers utilize electronic benefits transfers, or EBTs. Electric benefits transfer is a method that our government uses to pay welfare recipients. Previously, welfare recipients would receive a check from the government every month. However, more recently, the government has issued a card to the welfare recipients. Every month that card gets credited with the amount the recipient will receive for welfare. They are able to use that card to make all their purchases and if needed be able to go to an ATM to get cash. Consequently, the recipients of EBTs need not utilize traditional financial institutions.

Similarly, check cashing and payday loans are financial transactions that have greatly grown in number. Typically, such transactions are not carried out at a traditional bank. Instead, for payday loans and check cashing, centers are typically used. Payday loan|/check cashing centers have sprouted up all over the United States over the last several years. Typically these centers are set up as stand-alone stores manned by a clerk who is an employee of the creditor. A consumer interacts with a clerk manning the counter. The clerk assists the consumer in completing the paperwork for the payday loan and/or check to be cashed. After completion of the paperwork and acceptance by the creditor, the clerk may provide the payday loan or cash the check. Thus, a live person at the same location as the customer provides service. A live person takes the information from the customer and guides the customer in getting the payday advance (loan) or check cashed. In other industries, there are similar manned kiosks. For example, there are kiosks in fast food chains that use kiosks to take orders. Such a kiosk is manned by a physical person who assists their customers using these kiosks.

Although such centers function, there are several drawbacks. The cost of setting up and manning such centers is significant. For example, the creditor pays to provide adequate security for the clerk and cash kept by the clerk. In addition, the clerk manning the center is paid. Furthermore, payday loans typically have a high risk of nonpayment. There is no collateral and the creditors rely on the customer to pay back the loan. As a result, such loans are very risky. Consequently, these loans are typically high in cost. Many such loans have a cost that typically ranges from a low of 10% to as high as 20% for short-term loans that normally have a duration of no longer than two weeks. These fees correspond to fees that are as high as 500% a year. Consequently, both the cost of setting up such centers and the cost to the consumer are high.

Self service kiosks have found limited use in providing financial services. For example, the ATM is a kiosk that has been accepted by the public. ATMs may be seen throughout the United States, for example in convenience stores, liquor stores, gas stations, and shopping centers. Bill payment is a financial service that has been proven successful out of the kiosk over the last couple of years. There are already a few companies that have deployed bill payment kiosks in the United States.

Although limited financial services, such as ATM transactions and bill payment, have been provided through kiosks, in general, attempts to provide additional financial services have significant drawbacks. Typically, kiosks for such services are large, complex and, therefore, intimidating. Consequently, consumers are reluctant to use such kiosks. In addition, the only support in some of these types of kiosks is a phone the customer can use to initiate communication with a call center. In addition, transactions such as payday loans and check cashing are complex and thus difficult to complete from a self-service kiosk. Payday loans typically require the customer to fill out complex paperwork and perform other complicated tasks. Such tasks are difficult to do without the assistance of a clerk at the location of the customer.

Consequently, what is needed is an improved method and system for carrying out financial transactions, such as payday loans, check cashing, EBT advances, and/or money transfers.

### BRIEF SUMMARY OF THE INVENTION

A method and system for providing remote financial services are described. The method and system include receiving a request for financial transaction(s) from a customer through a kiosk at a remote location. The kiosk includes a first camera and a display, and is coupled with a call center at a location physically distinct from the remote location. The call center includes a second camera for an individual at the call center. The method and system also include displaying image(s) of the individual on the display of the kiosk to provide a virtual attendant at the remote location for assisting the customer with the at least one financial transaction. Data is transferred between the call center and the kiosk. A first portion of the data is transferred from the call center to the kiosk and displayed on the display for the kiosk. A second portion of the data is transferred from the kiosk to the call center and being displayed to the individual. The method and system also include dispensing funds from the kiosk if the financial transaction is successful.

According to the method and system disclosed herein, the virtual attendant, the individual at the call center, can assist customers at remote locations. As a result, assistance with financial transactions may be centralized, facilitated, and made more efficient.

### BRIEF DESCRIPTION OF SEVERAL VIEWS OF THE DRAWINGS

FIG. 1 depicts an exemplary embodiment of a method for providing remote financial services.

FIG. 2 depicts an exemplary embodiment of a kiosk for providing remote financial services.

FIG. 3 depicts another exemplary embodiment of a system for providing remote financial services including a kiosk and a call center.

FIG. 4 depicts another exemplary embodiment of a method for providing remote financial services.

FIG. 5 depicts another exemplary embodiment of a method for providing remote financial services.

FIG. 6 depicts another exemplary embodiment of a method for providing remote financial services.

FIG. 7 depicts another exemplary embodiment of a method for providing remote financial services.

### DETAILED DESCRIPTION OF THE INVENTION

The method and system relate to financial services. The following description is presented to enable one of ordinary skill in the art to make and use the invention and is provided in the context of a patent application and its requirements. Various modifications to the embodiments and the generic principles and features described herein will be readily apparent to those skilled in the art. Thus, the method and system are not intended to be limited to the embodiments shown, but is to be accorded the widest scope consistent with the principles and features described herein.

The method and system are mainly described in terms of particular systems provided in particular implementations. However, one of ordinary skill in the art will readily recognize that this method and system will operate effectively in other implementations. For example, the systems, devices, and networks usable with the present invention can take a number of different forms. The method and system will also be described in the context of particular methods having certain steps. However, the method and system operate effectively for other methods having different and/or additional steps not inconsistent with the method and system.

The method and system utilize overhead screens in communicating information to the people who visit locations at which at least portions of the method and system may be implemented, particularly kiosks. Consequently, the method and system are described in the context of kiosks. However, other stations at various locations may be used. The method and system can use news weather educational information and advertising as different content that could be provided in each kiosk. This information and advertising may be part of or supplement the methods and system described herein. As thousands of these kiosks are placed around the nation, the method and system are able to provide broadcasting and other contents to inform people like the radio and TV does from their homes. Although customers most likely conduct their first transactions on these kiosks, in one embodiment, at least some future transactions may be able to be accomplished through the Internet from a computer. With kiosks, the high cost of traditional bank branches may be reduced or eliminated and the savings passed on to customers.

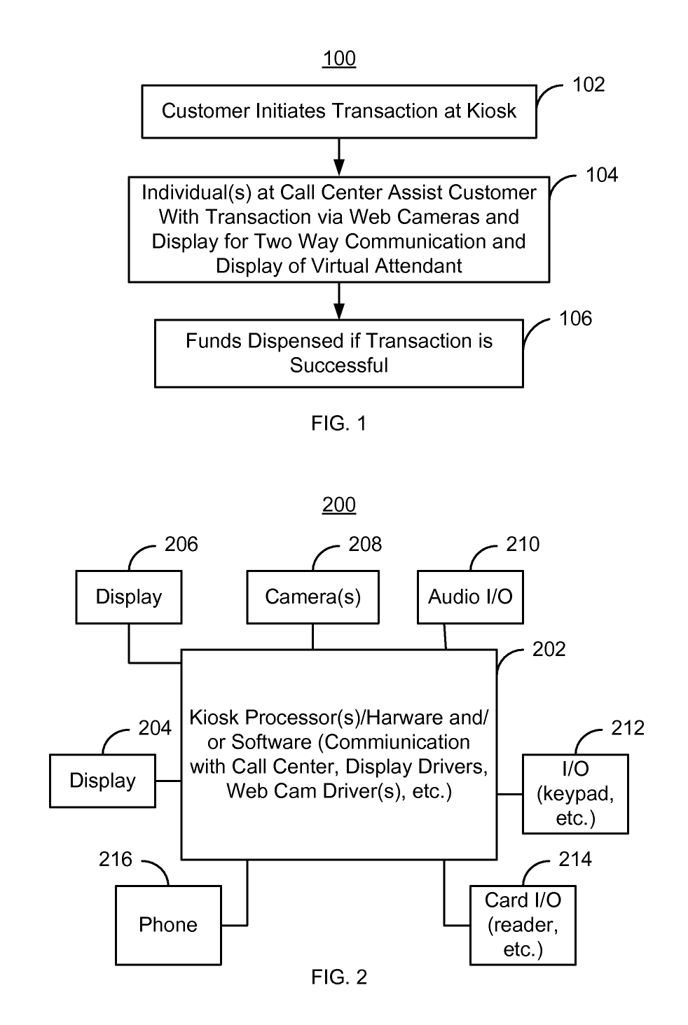

FIG. 1 depicts an exemplary embodiment of a method 100 for providing financial services to users. The method 100 may be implemented using a kiosk the customer utilizes and a call center used to service the kiosk. In such an embodiment, the call center and kiosk are located at physically distinct locations. Thus, the location of the kiosk is remote from the location of the call center. Further, the call center may be used to service multiple kiosks at the same or different locations. The method 100 is also described in the context of particular steps. However, one of ordinary skill in the art will recognize that steps may be omitted or combined and that additional steps (not shown) could be added.

The method 100 may be used in connection with providing a variety of services, particularly financial services. The services provided may include payday loans, discounted payday loans, EBT transactions, EBT advances, bill payments, money transfer, money management, budgeting, check-cashing, advertising, ring tone downloads, monthly statements, health savings account insurance, prepaid cards, stored value cards, gift cards, card to card transfers, investing, and travel bookings. In one embodiment, the method 100 may be used to provide at least one of check cashing, payday loans, EBT advances and money transfers.

A request for financial transaction(s) is received from the customer(s), via step 102. In one embodiment, the request is made through a kiosk. In such an embodiment, the request might be considered made when the customer(s) activate kiosk(s) at their locations, for example by swiping a card such as an identification card (e.g. driver's license or state identification), a personal identification number (PIN)-based card, or a signature based card such as a credit or debit card. In another embodiment, step 102 includes receiving the request at a call center. The call center is at a location remote from the kiosk and is staffed by individual(s). Stated differently, the kiosk and call center are located at physically disparate areas. For example, the call center might be around the corner from the kiosk. In another embodiment, the kiosk and call center may be separated by miles, hundred of miles, or thousands of miles. In one embodiment, the call center is staffed by multiple individuals. However, in another embodiment, a single individual may staff the call center. In addition, the call center may handle financial transactions from a single kiosk, a single location including a group of kiosks, or multiple kiosks from multiple locations.

In one embodiment, the kiosk includes at least one camera, such as a web-camera, and at least one display. The call center may also include at least one camera, such as a web-camera, and one or more displays. In one embodiment, step 102 includes providing an initial response to the customer's request to determine what type of financial transaction is desired as well as the customers' response. The camera at the call center may be used to provide images of the individual(s) staffing the call centers on the display of the kiosk. Stated differently, a virtual attendant corresponding to the individual may be provided at the kiosk. The virtual attendant may be image(s) of the individual captured by the camera at the call center and displayed on the display(s) of the kiosk. Alternatively, the virtual attendant may be animated rather than a captured image. The response to the user's request may include the virtual attendant greeting the customer and asking the customer in what kind of transaction they customer would like to engage.

Assistance of the individual(s) for the financial transaction(s) is provided through the virtual attendant, via step 104. Stated differently, the cameras and display(s) are used to provide the assistance. For example, the individual, pictured as the virtual attendant on the display of the kiosk, may ask questions of the customer, fill out paperwork for the customer, and/or provide other assistance. The paperwork being filled out by the individual may be displayed to the customer on the kiosk's display or printed out. Image(s) of the customer, the customer's identification card, checks or other documents may be captured by the camera(s), or scanners, at the kiosk. Thus, the customer may be assisted in completing relatively complex financial transactions at the kiosk. For example, the customer may be assisted in filling out and signing forms for a payday loan or advance on an EBT advance or in cashing a check. Thus, two-way communication via cameras and displays, for example via web-cams, is used to provide assistance to the customer via the virtual attendant.

If the transaction is successful, then funds may be dispensed from the kiosk, via step 106. For example, the customer may be provided with a PIN-based card on which the funds have been loaded. Alternatively, the customer might swipe their PIN-based card, signature-based card, or other card(s) corresponding to a financial account on which the funds are desired. In such a case, step 106 would include loading the funds onto the card(s) provided by the customer. In another embodiment, cash might be dispensed in step 106.

Using the method 100, customers may receive assistance of a live individual at the call center through the virtual attendant depicted on the display of the kiosk. Use of the kiosk may be made less intimidating and more personal. Further, the customer may be provided with sufficient assistance to complete transactions which would be difficult or impossible without the individual's help. Thus, the customer may be more likely to use the kiosk for such financial transaction. Because individual(s) at call centers can service more locations, the costs of maintaining payday loan or analogous sites may be reduced and the efficiency improved. Consequently, the provider of the financial services may also benefit from the method 100. Consequently, remote financial transactions may be facilitated.

FIG. 2 depicts an exemplary embodiment of a kiosk 200 for providing financial services. In one embodiment, the kiosk 100 includes a processor 202 that could also be considered software and hardware 202 for performing financial transaction such as dispensing funds or cards, accepting input from a customer, providing output to the customer, and communicating with a call center (not shown in FIG. 2). In one embodiment, the kiosk also includes displays 204 and 206, at least one camera 208, audio input/output (I/O) 210 such as a speaker and/or microphone, other I/O subsystem 212 such as a keypad, a card input/output system 214, and phone 216. In one embodiment, the camera(s) 208 are web-cams. The displays 204 and 206 may be used to provide information to the customer, for example in the form of text, and to display a call center employee (not indicated in FIG. 2) during a transaction. Although the card I/O system 214 is indicated as a single system in FIG. 2, it is typically multiple subsystems. For example, the card I/O system 214 may include a card reader (not separately shown) and a mechanism for outputting a new card and/or adding funds to an existing card. Thus, in one embodiment, the card I/O 214 may be used to dispense funds. In another embodiment, a separate system (not explicitly shown in FIG. 2) may be used to dispense funds. In one embodiment, the phone 216 may be provided in order to allow the customer to complete the transaction more privately. If the customer elects to use the phone, then audio, such as the virtual attendant's voice, is output over the receiver of the phone and received from the microphone of the phone.

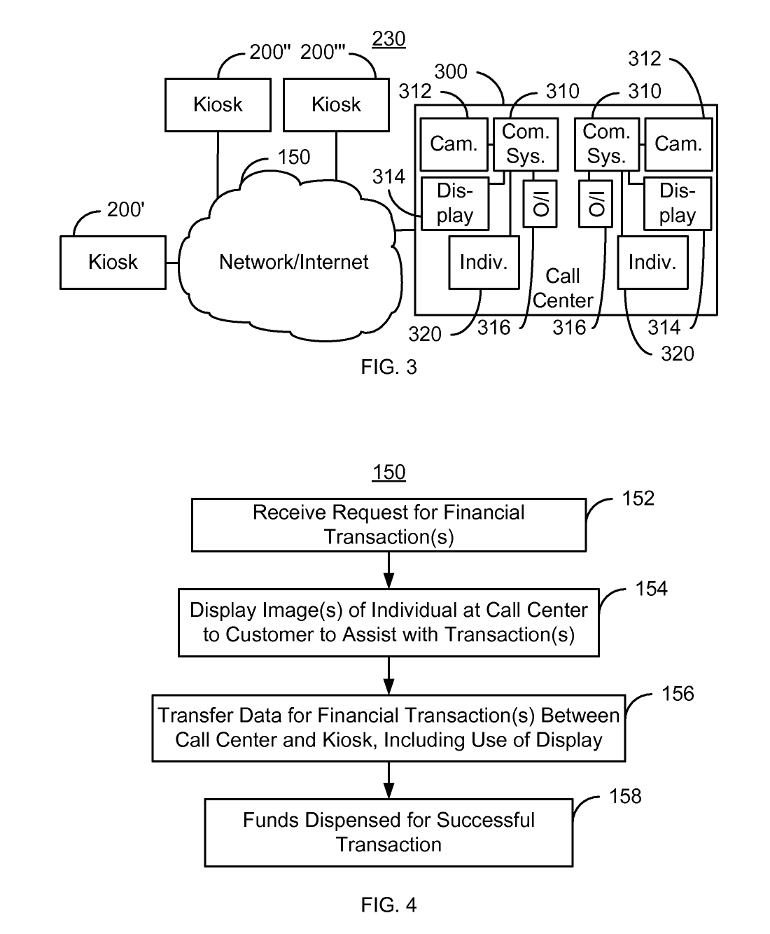

FIG. 3 depicts an exemplary embodiment of a system 230 for providing financial services. The system 230 utilizes one or more of the kiosks 200. Thus, the system 230 depicted in FIG. 3 includes kiosks 200′, 200″, and 200′″, network 250, and at least one call center 200. The kiosks 200′, 200″, and 200″ are preferably embodiments of the kiosk 200 and thus may include analogous equipment and perform analogous functions. In addition, the kiosks 200′, 200″, and 200′″, may be located at widely different locations. The network 250 may include the Internet, a LAN, and/or WAN. The call center 300 includes computer systems 310 staffed by employees (or other individuals) 320. The computer system 310 includes cameras 312, displays 314, and I/O systems 316. Using the I/O system 316, an individual 320 may provide input to the computer system 310. For example, the individual 320 may type in information to a loan application. The displays 314 may be used to display images from the camera 312 or from the kiosk 200/200′/200″/200′″. The camera 312 may be a web-cam. Thus, the web-cam 312 may be used to provide image(s) of the individual 320 to the customer (not shown in FIG. 3) at the kiosk 200/200′/200″/200′″.

Referring to FIGS. 2 and 3, the kiosk 200 and the system 230 may be used in performing the method 100. The kiosk 200 and system 230 utilize the web-cam 208, or analogous technology, and displays 206, 208 to provide the services disclosed herein. The web-cams 208 and 312 provide two-way video input and output. More specifically, the web-cam 208/312 provides a feed of video of a call center individual 220 to the customer, for example via the display 206 or a feed of video of the customer or other item at the kiosk 200/200′/200″/200″ to the display 314. More particularly, financial services such as payday loans and check cashing may be facilitated using a two-way web-cam 208 or 312. In a preferred embodiment, the display 206 may be mounted at the top of the kiosk 200 and may be large. Furthermore, when not in use for facilitating a financial transaction for a customer, the display 206 may provide other information including but not limited to advertising, financial information, news or other data.

The kiosk 200/200′/200″/200′″ is substantially a self-serve kiosk. Consequently, a customer may perform a number of transactions by themselves. For example, the 200/200′/200″/200′″ kiosk might function as an ATM, or simply allow the customer to perform any portion of the transactions described herein, such as obtaining a payday loan, by themselves. However, the two way web-cam 208 allows an individual 320 at the call center 300 to aid a customer at the kiosk 200/200′/200″/200′″ in obtaining financial services. The individual 320 at the call center 300 may perform substantially the same functions as a live person at a check cashing/payday loan center. However, the individual 320 is not physically located at the kiosk 200/200′/200″/200′″.

Communication between the consumer and the company offering the financial services preferably takes place via the two-way web-cam 208, displays 204/206 and audio input/output 210 and well as through web-cam 312 and display 314. In one embodiment, the web-cams 208 are provided on the kiosk 200 with a screen 206 to display the face of the individual 320. This is accomplished by having the camera 312 pointed at the face of the individual 320 at the call center 300 and displaying the individual's face to the customer at the kiosk. Thus, through the web-cam 208, display 206, audio I/O 210, and call center individual 320, a virtual attendant is provided for the kiosk 200. In addition, the customer may optionally utilize the display 204, which is preferably in the middle of the kiosk 200. Use of the centrally located display 204 may improve the privacy of the customer. By providing a virtual attendant, the two-way web-cam 208 and remainder of the kiosk 200 and system 230 may provide better service which may mean making additional revenue by providing more services. The web-cam enabled kiosk 200 thus takes the place of an actual live person representing the company. Instead, an individual 320 at a call center 300 representing the company is displayed to a consumer via the display 204 or 206. The individual 320 at the call center 300 can lead the customer through the paperwork required in obtaining a loan or cashing a check as described in the method 100. In one embodiment, the individual 320 manning the call center 320 actually enters the information for the customer, which may then be displayed to the customer, for example on the display 204 or 206, to ensure correctness.

Thus, the web-cam technology provides the customer service for various types of financial services. This kiosks 200/200′/200″/200′″ may be a multidimensional kiosks that allows for the expansion of services as needed simply by having an individual there by way of a virtual attendant. The virtual attendant corresponding to the individual 320 may help each customer as if the individual 320 were personally at the remote location of the kiosk 200/200′/200″/200′″. The kiosks 200/200′/200″/200′″ may be located in shopping centers, convenience stores, food marts, grocery stores, employer's businesses, as well as other locations. In addition to the services listed, the display 204 and/or 206 on the kiosks 200/200′/200″/200′″ may be used to advertise, educate and promote goods and/or services, particularly those of the owner of the kiosk 200/200′/200″/200′″. For example, one or more of the displays 204 and 206 of the kiosks 200/200′/200″/200′″ may be overhead display and used to display the attendant. Alternatively, multiple displays 204 and 206 may be provided on the kiosk. The screen(s) 204 and/or 206 may be a platform for providing continuous showings for example of advertising and/or promotional material. Typically, contracts for kiosks 200/200′/200″/200′″ allow the kiosk 200/200′/200″/200′″ to remain for long periods. For example, contracts with each location for 10 years are not unusual. During these years, the display 204 and/or 206 may provide the opportunity to promote and educate the public on other goods and services. Customers may be able to sign up, open an account, and be able to save on financial services using the kiosk 200/200′/200″/200′″.

Furthermore, the system 230 may be extended to other industries having self-service kiosks and provide better service than conventional systems. For example, kiosks in fast food chains are used to take orders. Such a kiosk is manned by a person physically located at or near the kiosk and who assists their customers using these kiosks. Two-way enabled system 230 used in conjunction with a kiosk 200/200′/200″/200′″ may eliminate the need for a live person at such a kiosk. The virtual attendant, who may actually be at a central location such as the call center 300 and whose presence is provided via the web-cams 208 and 312 and displays 204, 206, and 314, may provide the same type of service to these customers. Because the virtual attendant can manage multiple kiosks from the central location, payroll expenses may be reduced. Similarly, the method 100, kiosk 200 and system 230 may be used in airports terminal kiosks, for example to issue tickets to customers. Typically, there are a couple of attendants physically at the airport kiosk to help customers. Use of a two-way system 230 add kiosk 200/200′/200″/200′″ may accomplish substantially the same tasks. Thus, superior service may be provided for the customer using the kiosk 200/200′/200″/200′″. At the movie theaters conventional self-service kiosks already exist. The two-way system 230 and kiosk 200/200′/200″/200′″ a customer may be guided in purchasing tickets more efficiently. Thus, the kiosk 200/200′/200″/200′″, system 230, as well as the methods described herein, may be extended to other industries.

For example, FIG. 4 depicts an exemplary embodiment of a method 150 for providing financial services utilizing the system 230 and kiosk 200. The method 150 may be implemented using a kiosk 200/200′/200″/200′″ the customer utilizes and a call center 300 used to service the kiosk 200/200′/200″/200′″. In such an embodiment, the call center 300 and kiosk 200/200′/200″/200′″ are located at physically distinct locations. Thus, the location of the kiosk 200/200′/200″/200′″ is remote from the location of the call center 200/200′/200″/200′″. Thus, the method 150 is described in connection with the kiosk 200 and system 230 depicted in FIGS. 2 and 3. Referring to FIGS. 2-4, the call center may be used to service multiple kiosks at the same or different locations. The method 150 is also described in the context of particular steps. However, one of ordinary skill in the art will recognize that steps may be omitted or combined and that additional steps (not shown) could be added.

The method 150 may be used in connection with providing a variety of services, particularly financial services. The services provided may include payday loans, discounted payday loans, EBT transactions, EBT advances, bill payments, money transfer, money management, budgeting, check-cashing, advertising, ring tone downloads, monthly statements, health savings account insurance, prepaid cards, stored value cards, gift cards, card to card transfers, investing, and travel bookings. In one embodiment, the method 150 may be used to provide at least one of check cashing, payday loans, EBT advances, and/or money transfers.

A request for one or more financial transactions is received from a customer through a kiosk 200/200′/200″/200′″ at a remote location, via step 152. In one embodiment, step 152 includes the user inserting or swiping a card, such as a PIN-based card, a signature-based card, a driver's license, a state identification, or other form of identification. In one embodiment, step 152 includes validating the user's identity based on the card swiped Step 152 may also include a greeting being provided to the customer and a prompt requesting that the customer selects a transaction. Thus, step 152 may also include the user selecting the transaction. The customer may select a transaction, such as a payday loan or check cashing.

Image(s) of the individual 320 are displayed on the display 204/206 of the kiosk 200/200′/200″/200′″ to provide a virtual attendant at the remote location, via step 154. The virtual attendant is to assist the customer with the financial transaction(s) selected. Step 152 may include the individual 320 at the call center 300 receiving the call and, using the camera 312, establishing contact with the customer. In one embodiment, the virtual assistant is an image of the individual 320. However, in another embodiment, the virtual assistant might include an animated character corresponding to the individual 320. In addition, in one embodiment, the customer may also be displayed to the individual 320. Thus, face-to-face interaction between the customer and the individual 320 may be provided.

Data for the financial transaction(s) are transferred between the call center 300 and the kiosk 200/200′/200″/200′″, via step 156. Part of the data is transferred from the call center 300 to the kiosk 200/200′/200″/200′″ for display on the display 204 or 206. Step 156 may thus include the individual 320 filling out documents, for example for a loan application or money transfer. Step 156 may also include the documents being sent to the kiosk 200/200′/200″/200′″. This may include sending an image or other data file of the documents being sent to the kiosk 200/200′/200″/200′″. Another part of the data is transferred from the kiosk 200/200′/200″/200′″ to the call center 300 and displayed to the individual 320 in step 156. For example, the customer may review the documents, indicate his or her assent, and sign the documents. The signature may be transferred from a signature pad or other I/O device 212 to the call center 300. For example, the signature may be displayed on the display 314 for the individual 320 to review. In another embodiment, the individual 320 may allow the customer to fill out the paperwork, have the information transferred so that the individual 320 can view the documents and validate information provided. Thus, the two-way communication between the call center 300 and the kiosk 200/200′/200″/200′″ allows the individual 320, as a virtual assistant, to assist the customer with the transaction. More particularly, communication involving the web-cams 208 and 312 and displays 204/206 and 314 allows the individual 320 to provide significant assistant in the financial transaction.

Funds may be dispensed from the kiosk 200/200′/200″/200′″ if the financial transaction(s) are successful, via step 158. Thus, if the check cashing or loan is approved, the customer may receive the desired funds. In one embodiment, step 158 includes loading the funds onto a new card. In another embodiment, the funds may be provided on a gift card, an existing card, credited to a Pin-based or signature-based card, or other similar mechanism. In another embodiment, cash may be dispensed.

Through the method 150 a few or a single person at a corresponding call center 320 can manage several kiosks 200/200′/200″/200′″ from the call center 300. This is in contrast to traditional payday and check cashing centers, in which one person handles one customer and in which the one person needs to be at each physical location to provide service to each customer. Instead, the system 230 and method 150 allows the company offering the financial services to have all the individuals 320 at one or more central locations, the call center 300. Consequently, various financial services, such as payday loans, check cashing, and EBT advances may be offered via a kiosk that is “manned” via a virtual assistant and the system 230. As a result, the costs of offering such services may be significantly reduced without significantly sacrificing the quality of assistance available to a customer.

In one embodiment, use of a single PIN-based or signature-based card for providing funds in the method 100 and/or 150 may provide additional benefits. Dispensing funds via a card may make payment more secure. In particular, the method and system may reduce or eliminate high risk of having a kiosk full of cash, like an ATM, that increases the possibility of theft. These cards preferably have no value in them until a transaction is completed and approved. At the end of the transaction, the card has value added to that card. The card is then dispensed to the customer only after completion of a transaction. This is in contrast to traditional payday check cashing centers, which have high set-up costs for security reasons. For example, such Payday/check cashing centers often install bulletproof glass and additional security measures to protect their employees from robbery because of the cash contained in the center. Such security measures may be reduced or eliminated because no real person is present at the kiosk 100/100′/100″/100′″ and because funds may only be provided via the one card. Consequently, safety may be improved while setup costs are reduced.

Furthermore, a kiosk 200/200′/200″/200′″ in the system 230 may be provided at an employer for use by the employees in obtaining remote financial services such as payday loans. The kiosk 200/200′/200″/200′″ may be used for obtaining and/or adding value to a card. In particular, a kiosk 200/200′/200″/200′″ may provide payday “loans” by adding value to the PIN-based or signature-based card. If the employer pays the employee through the card, the risk for non-repayment for the company (the creditor of the payday loan or other advance) is lower. Thus, loans may be offered at discounted prices. In particular, a loan is associated with the card because the card will receive credits at every payday. As a result, a creditor may be able to provide short-term loans, such as payday loans, at a significant discount. For example, in one embodiment, a 50% discounts to the rates charged by conventional providers of payday loans. More specifically, at or around payday, the employee's (customer's/debtor's) card is credited by the employer. Because at least part of the customer's paycheck is deposited to the card automatically (e.g. through an automatic deposit), their loan obtained through the method 100/150 and system 230 may be subtracted from the paycheck and the difference credited to their card. This reduces the risk of default for the company and allows the customer to pay back their loan on time. In some embodiments, the short-term loan might be charged at a rate of $0.99 per day or lower. A person may pay back the following day or a few days from borrowing or on their next paycheck. At their next paycheck, their loan is automatically repaid and the remaining amount goes directly to their one card. Thus, in a preferred embodiment, such short term loans are provided via the one card.

The method 100/150 and system 230 may allow the call center 300 to be more effective than the traditional call centers currently utilized. The call centers that many industries use today assist the customers by voice only. By using the system 230, call centers may be more effective in dealing with these same customers. In one embodiment, the face of the call center attendant is displayed to the person contacting the call center and vice versa. By having the face displayed of both the call center attendant 220 and the customer contacting the call center, the interaction is more similar to the interaction that may take place if the call center attendant is physically present at the location of the customer contacting the call center. Thus, better service may be provided because the environment provided is such that the call center attendant 320 is present as though the individual (or call center attendant) 320 is at the location of the kiosk 200/200′/200″/200′″. Documents and any and other items could also be displayed to the customer contacting the call center to be able to demonstrate to the customer or show the customer items that that make it easier to help that customer.

The risks of starting a new location may be lowered by using kiosks 200/200′/200″/200′″ and the system 230 and method 100/150. Conventional payday check cashing and/or payday loan centers may spend hundreds of thousands of dollars doing leasehold improvements to operate their business. Although there is no guarantee that the location will be successful, such conventional check cashing and/or payday loan businesses must normally sign a multiyear lease. If the location is not profitable, the business may lose in many ways. For example, the business may lose the value of leasehold improvements, may be obligated to continue making payments on a multiyear lease, and/or may have costs associated with subleasing to a different entity. In contrast, if there are no profits or low profits, the kiosk 200/200′/200″/200′″ may simply be removed and, if desired, installed in a new location. Moreover, the difference in capital to start a new location for a kiosk 200/200′/200″/200′″ is dramatically lower than a conventional check cashing and/or payday loan center. A traditional payday check cashing center may cost as much as $250,000 for a new location. An unmanned kiosk 200/200′/200″/200′″ may average closer to about $25,000 per location. This may allow a more rapid expansion of a kiosk-based business using the method and system described herein across the United States.

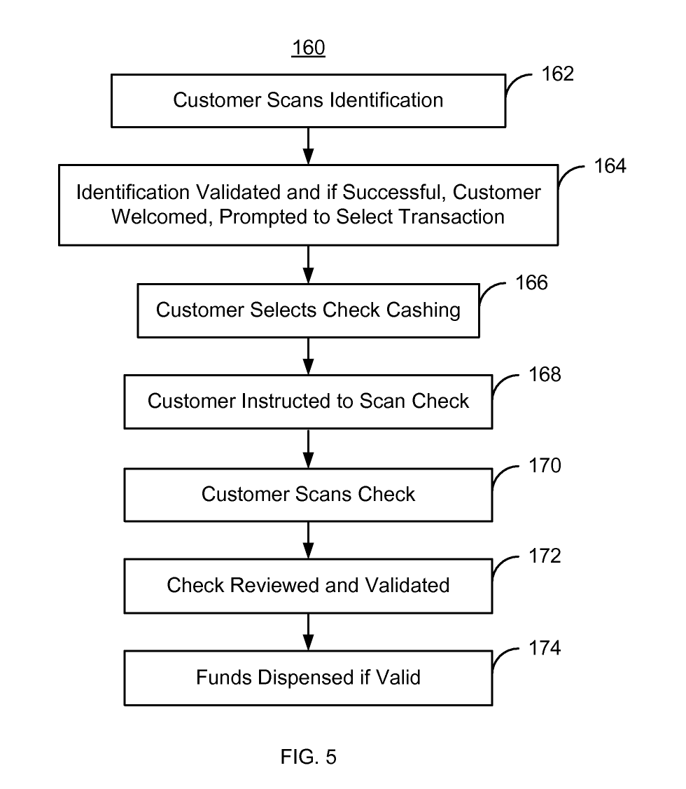

FIG. 5 depicts another exemplary embodiment of a method 160 for providing remote financial services. The method 160 may be implemented using a kiosk 200/200′/200″/200′″ the customer utilizes and a call center 300 used to service the kiosk 200/200′/200″/200′″. In such an embodiment, the call center 300 and kiosk 200/200′/200″/200′″ are located at physically distinct locations. Thus, the location of the kiosk 200/200′/200″/200′″ is remote from the location of the call center 200/200′/200″/200′″. Thus, the method 160 is described in connection with the kiosk 200 and system 230 depicted in FIGS. 2 and 3. Referring to FIGS. 2-3 and 5, the call center may be used to service multiple kiosks at the same or different locations. The method 160 is also described in the context of particular steps. However, one of ordinary skill in the art will recognize that steps may be omitted or combined and that additional steps (not shown) could be added. The method 160 may be used in connection with providing check cashing. Thus, the method 160 may be viewed as an application of the method 100 and/or 150.

The customer provides their identification to the kiosk, via step 162. In one embodiment, the customer does so by swiping a card, such as a driver's license or state identification, through the card reader 214 of the kiosk 200/200′/200″/200′″. The identification is validated, via step 164. In one embodiment, the validation determines whether the identification appears to be the type of identification indicated. For example, if the customer swipes a state driver's license, then it is determined in step 164 whether the card swiped has the look and field of that particular state's license. In another embodiment, the identity of the individual on the card is validated. For example, the user's identity may be validated against information in a database. Also in step 164, if the validation is successful, the customer may be welcomed and prompted to select a transaction. The welcome and prompt may be provided on the display 204 and 206 and may be the virtual attendant for the individual 320.

The customer selects check cashing, via step 166. The customer is instructed to scan in the check, via step 168. In one embodiment, the virtual attendant provided on the display 204/206 from the call center 300 provides the instructions. For example, for new customers, the virtual attendant may provide the instructions. A returning customer may complete the transaction without the use of the virtual attendant's instructions. However, in one embodiment, the customer may request the assistance of the virtual attendant, which would be provided in step 168. The customer scans the check, via step 170. The check is reviewed, via step 172. In one embodiment, the individual 320 reviews an image of the check and determines whether to approve the check. If the check is approved, then funds are dispensed, via step 174. In one embodiment, the funds are dispensed on a card in step 174. In another embodiment, the funds may be provided as cash or in another manner.

Using the method 160 and the system 230, a user can be assisted in cashing a check. Because the individual 320 may provide the assistance as the virtual assistant, a single individual 320 may assist numerous customers at kiosks 200/200′/200″/200′″ at widely different locations. Consequently, the costs and risks of offering such services may be significantly reduced without significantly sacrificing the quality of assistance available to a customer.

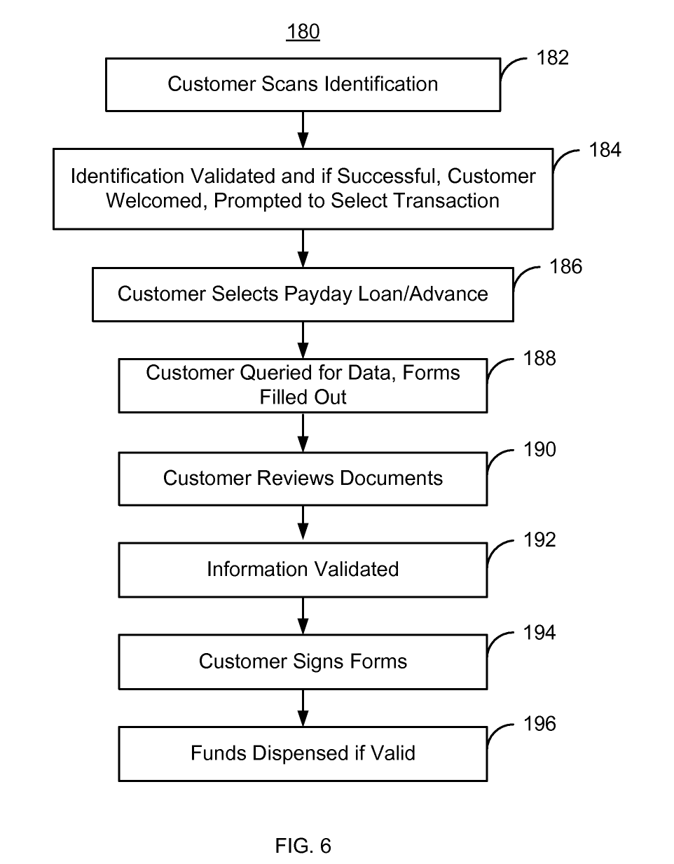

FIG. 6 depicts another exemplary embodiment of a method 180 for providing remote financial services. The method 180 may be implemented using a kiosk 200/200′/200″/200′″ the customer utilizes and a call center 300 used to service the kiosk 200/200′/200″/200′″. In such an embodiment, the call center 300 and kiosk 200/200′/200″/200′″ are located at physically distinct locations. Thus, the location of the kiosk 200/200′/200″/200′″ is remote from the location of the call center 200/200′/200″/200′″. Thus, the method 180 is described in connection with the kiosk 200 and system 230 depicted in FIGS. 2 and 3. Referring to FIGS. 2-3 and 6, the call center may be used to service multiple kiosks at the same or different locations. The method 180 is also described in the context of particular steps. However, one of ordinary skill in the art will recognize that steps may be omitted or combined and that additional steps (not shown) could be added. The method 180 may be used in connection with providing payday loans. Thus, the method 180 may be viewed as an application of the method 100 and/or 150.

The customer provides their identification to the kiosk, via step 182. In one embodiment, the customer does so by swiping a card, such as a driver's license, state identification or other card, through the card reader 214 of the kiosk 200/200′/200″/200′″. In one embodiment, the card used may be a PIN-based or signature-based card. The identification is validated, via step 184. In one embodiment, the validation determines whether the identification appears to be the type of identification indicated. For example, if the customer swipes a state driver's license, then it is determined in step 184 whether the card swiped has the look and field of that particular state's license. In another embodiment, the identity of the individual on the card is validated. For example, the user's identity may be validated against information in a database. Also in step 184, if the validation is successful, the customer may be welcomed and prompted to select a transaction. The welcome and prompt may be provided on the display 204 and 206 and may be the virtual attendant for the individual 320.

The customer selects a payday loan or similar advance, via step 186. The customer is queried and the corresponding forms filled out, via step 188. For example, the customer may be queried regarding their employer, how long they have been at their current job, other employment information, their bank accounts, and other information. In one embodiment, the other information may include a utility bill. In one embodiment step 186 includes obtaining at least some of this information from the user's identification scanned in step 182. In one embodiment, the virtual attendant queries the customer and the individual 320 enters the information to the computer system 310. In such an embodiment, the customer does not have independent access to the documents while the individual 320 is entering the information. The customer is allowed to review the documents, via step 190. In one embodiment, the data entered into the loan documents at the call center 300 is provided to the kiosk 200/200′/200″/200′″ and displayed on the display 204 and/or 206. Thus, the customer may view the documents. In one embodiment, the customer may view the documents as they are prepared.

The information provided by the customer and entered into the documents by the individual 320 is validated, via step 192. In one embodiment, step 192 includes running the information through a service such as telecheck. The customer then provides their signature, via step 194. In one embodiment, the customer signs on a signature pad. The signature is electronically transmitted to the call center 300 and added to the document(s) in the appropriate location(s). Thus, the customer agrees to abide by the loan agreement. The funds may then be dispensed, via step 196. In one embodiment, the funds are dispensed on a card in step 196. In another embodiment, the funds may be provided as cash or in another manner.

Using the method 180 and the system 230, a user can be assisted in obtaining a payday loan. Because the individual 320 may provide the assistance as the virtual assistant, a single individual 320 may assist numerous customers at kiosks 200/200′/200″/200′″ at widely different locations. Consequently, the costs and risks of offering such services may be significantly reduced without significantly sacrificing the quality of assistance available to a customer. Further, if the funds are dispensed to a card on which their employer also pays the customer, the risk to the creditor and the cost to the customer further reduced.

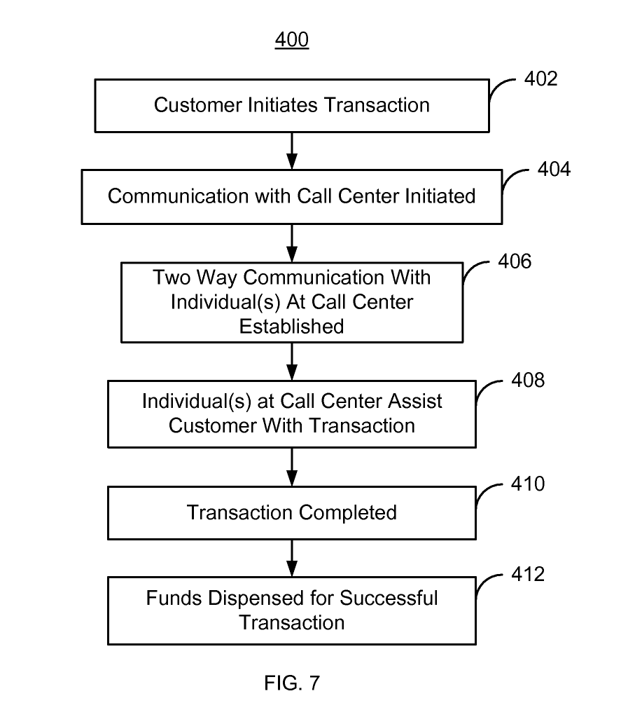

FIG. 7 depicts an exemplary embodiment of a method 400 for providing financial services utilizing the system 230 and kiosk 200. Thus, the method 400 is described in connection with the kiosk 200 and system 230 depicted in FIGS. 2 and 3.

Referring to FIGS. 2-3 and 7, a customer initiates a transaction at a kiosk 200/200′/200″/200″, via step 402. In one embodiment, the customer may insert or swipe a card, such as an identification. The processor/hardware and/or software 202 of the kiosk 200/200′/200″/200″ determines the identity of the customer and allows the customer to select from transactions. The customer selects a transaction, such as a payday loan or check cashing and, in a preferred embodiment, the kiosk 200/200′/200″/200″ establishes communication with the call center 300, via step 404. In one embodiment, the kiosk 200/200′/200″/200′″ initiates communication to the call center 300 for each transaction. In another embodiment, the kiosk 200/200′/200″/200′″ may establish communication with the call center 300 only if requested by the customer. One of the individuals 320 takes the call at the call center 300 and using the computer system 310 (which is may be web-cam enabled through cameras 312 and includes display 314), the web-cam 208, display 206 and display 204, and audio I/O, two-way communication between the individual 320 at the call center 300 and the customer at the kiosk 200/200′/200″/200′″ may be established, via step 406.

The individual 320 at the call center 300 assists the customer with the transaction via the kiosk 200/200′/200″/200′″, via step 408. In step 408, the communication between the individual 320 at the call center 300 is two-way because of the presence of the web-cam 208, display 206, display 204, audio I/O 210 and computer system 310 including display 314 and camera 312. Consequently, in one embodiment, the individual 320 is shown to the customer and vice versa. Thus, as discussed above, the individual 320 may act as a virtual attendant, assisting the customer with the transaction from the call center 300 that may be located remote from the kiosk 200/200′/200″/200′″. For example, the individual 320 may aid the customer in filling out paperwork. In one embodiment, the individual 320 may ask the customer questions, fill out the paperwork on behalf of the customer, and display the paperwork to the customer on the display 204 or 206. Alternatively, the individual 320 may allow the customer to fill out the paperwork, and simply validate information provided.

The transaction may be completed, via step 410. Step 410 may include obtaining the signature form the customer or otherwise completing the transaction except for providing funds for the customer. Once the transaction is completed, if the transaction is approved, then the funds may be dispensed, via step 412. Thus, if the check cashing or loan is approved, the customer may receive the desired funds.

In some embodiments, once the transaction is complete, the funds are dispensed in step 412 via a card. A card may be a PIN-based card, such as a stored value card, or a signature-based card, such as a debit or stored value card or credit card. The card may be filled by a variety of mechanisms, including allowing an employer to provide payment to their employees. In addition, the card may be used in tracking, money management, and budgeting. Customers may use their card for their paycheck and for all (or a substantial number) of their purchases. This use of the card offers the opportunity to track, itemize and categorize each expense and to inform them of their finances, preferably through custom color graphs of where they are at financially on a daily and weekly or monthly basis. Use of such a card may make banking fun (for example via rewards for use) as well as may teach people how to take complete control of their finances by using one card for their paychecks and for all their purchases. By using card for all of their purchases, the expenses may be tracked and categorized in an appropriate format. In one embodiment, the tracking system may compile not only the income (e.g. the value stored on the card by the employer) but also track and categorize of each expense. Furthermore, the card may be a universal card, capable of storing information from and being used in place of other credit, stored value, or other card(s). In step 412, the card is filled using the kiosk 200/200′/200″/200′″.

Consequently, a single person at a corresponding call center 320 may manage several kiosks 200/200′/200″/200′″ from the call center 300. This is in contrast to traditional payday and check cashing centers, in which one person handles one customer and in which the one person needs to be at each physical location to provide service to each customer. Instead, the web-cam enabled system 230 allows the company offering the financial services to have all the individuals 320 at one or more central locations, the call center 300. In addition, the kiosks 200/200′/200″/200′″ that are at various locations may be manned by the call center(s) 300. Consequently, the services disclosed herein, including but not limited to payday loans, check cashing, EBT loans, and the one card, may be offered via a kiosk that is “manned” via a web-cam.

Through the system 230 and method 400, individual(s) 320 at the call center 300 may man multiple kiosks 200/200′/200″/200′″. By being able to eliminate the costs of hiring employees at each kiosk 200/200′/200″/200′″, the kiosks 200/200′/200″/200′″ allow payday loans, check-cashing, bill payments, money transfers, and many other services to be provided at lower cost to the customers with the personal attention of having someone there—the virtual attendant provided using the method 400 and system 230. Through web-cam technology in the system 230 and method 400, communication directly with the customers as if an individual 320 was there personally behind a counter as traditional payday loan centers may provide a significant benefit in the form of greatly reduced costs.

The kiosks 200/200′/200″/200′″ are manned through a call center 300 with account specialists to guide the customer through the kiosk service. In one embodiment, two displays 204 and 206 on each kiosk 200/200′/200″/200′″ allow the display of the call center attendant (individual 320) face. Thus, each customer will be able to be face-to-face as they transact the transaction. Additionally, in a preferred embodiment, a camera 208 on the kiosks 200/200′/200″/200′″ displays the customers face to the call center attendant 320.

Thus, the web-cam technology provides the customer service for various types of financial services. This kiosks 200/200′/200″/200′″ may be a multidimensional kiosks that allows for the expansion of services as needed simply by having an individual there by way of a virtual attendant. The virtual attendant may help each customer as if the individual 320 were personally at the kiosk 200/200′/200″/200′″ location. The kiosks 200/200′/200″/200′″ may be located in shopping centers, convenience stores, food marts, grocery stores, employer's businesses, as well as other locations. In addition to the services listed, the screen 204 and/or 206 on the kiosks 200/200′/200″/200′″ may be to advertise, educate and promote goods and/or services, particularly those of the owner of the kiosk 200/200′/200″/200′″. For example, the kiosks 200/200′/200″/200′″ may include an overhead display 204 or 206 that may be used to display the attendant. Alternatively, multiple displays 204 and 206 may be provided on the kiosk. The screen(s) 204 and/or may be a platform for providing continuous showings for example of advertising and/or promotional material. Typically, contracts for kiosks allow the kiosk to remain for long periods. For example, contracts with each location for ten years are not unusual. Thus, the services and products described herein may be provided via the self-service, web-cam enabled kiosk 200/200′/200″/200′″ for years. During these years, the display 204 and/or 206 may provide the opportunity to promote and educate the public on other goods and services, including those disclosed herein. Customers may be able to sign up, start an account, and be able to save on all our financial services simply by having their employer pay them with card and use the kiosk 200/200′/200″/200′″.

A method and system for providing remote financial services has been disclosed. The method and system have been described in accordance with the embodiments shown, and one of ordinary skill in the art will readily recognize that there could be variations to the embodiments, and any variations would be within the spirit and scope of the present application. For example, the method and system can be implemented using hardware, software, a computer readable medium containing program instructions, or a combination thereof. Software written according to the present invention may be stored in some form of computer-readable medium, such as memory or CD-ROM, and executed by a processor. Accordingly, many modifications may be made by one of ordinary skill in the art without departing from the spirit and scope of the appended claims.

We claim:

1. A computer-implemented method for providing remote financial services comprising:
receiving a request for at least one financial transaction from a customer through a kiosk at a remote location, the kiosk including a camera and a display, the kiosk being coupled with a call center at a location, the remote location being physically distinct from the location of the call center, an individual corresponding to the call center and being located remote from customer;
providing assistance of the individual to the customer at the remote location using the first camera and the display, the assistance providing including displaying a virtual attendant on the display at the remote location and providing at least one image from the camera on the kiosk, the virtual attendant corresponding to the individual and for assisting the customer with the at least one financial transaction; and
dispensing funds from the kiosk if the at least one financial transaction is successful.

2. A computer-implemented method for providing remote financial services comprising:
receiving a request for at least one financial transaction from a customer through a kiosk at a remote location, the kiosk including a first camera and a display, the kiosk being coupled with a call center at a location, the remote location being physically distinct from the location of the call center, the call center including a second camera for an individual at the call center;
displaying at least one image of the individual on the display of the kiosk to provide a virtual attendant at the remote location for assisting the customer with the at least one financial transaction;
transferring data for the at least one financial transaction between the call center and the kiosk, at least a first portion of the data being transferred from the call center to the kiosk and displayed on the display for the kiosk, at least a second portion of the data being transferred from the kiosk to the call center and being displayed to the individual; and
dispensing funds from the kiosk if the at least one financial transaction is successful.

3. The method of claim 2 wherein the at least one financial transaction includes at least one of a payday loan, check cashing, an advance on an electronic benefits transfer, and a money transfer.

4. The method of claim 3 wherein the first portion of the data includes an unsigned loan application and wherein the second portion of the data includes a signature of the customer.

5. The method of claim 2 wherein the request receiving further includes:
receiving identification data for the customer for validation; and
receiving a selection of the at least one financial transaction.

6. The method of claim 5 wherein the receiving further includes:
reading data from a card swiped by the customer.

7. The method of claim 6 wherein the card includes at least one of a personal identification number-based card, a signature-based card, a driver's license, and a state identification card.

8. The method of claim 2 wherein the dispensing funds further includes:
loading a card with an amount corresponding to the funds, the card including at least one of a signature-based card and a personal identification number-based card.

9. An executable software product stored on a computer-readable medium containing program instructions for providing remote financial services, the program instructions for:
receiving a request for at least one financial transaction from a customer through a kiosk at a remote location, the kiosk including a first camera and a display, the kiosk being coupled with a call center at a location, the remote location being physically distinct from the location of the call center, the call center including a second camera for an individual at the call center;
displaying at least one image of the individual on the display of the kiosk to provide a virtual attendant at the remote location for assisting the customer with the at least one financial transaction;
transferring data for the at least one financial transaction between the call center and the kiosk, at least a first portion of the data being transferred from the call center to the kiosk and displayed on the display for the kiosk, at least a second portion of the data being transferred from the kiosk to the call center and being displayed to the individual; and
dispensing funds from the kiosk if the at least one financial the transaction is successful.

10. A kiosk for providing remote financial services, the kiosk residing at a remote location, the kiosk comprising:
at least one input device for receiving a request for at least one financial transaction from a customer; and
at least one processor coupled with the at least one input device, the at least one processor coupled with a call center at a location, the remote location being physically distinct from the location of the call center, the at least one processor also for transferring data for the at least one financial transaction between the call center and the kiosk, at least a first portion of the data being transferred from the kiosk to the call center and being displayed to the individual;
at least one display coupled to the at least one processor, the display for displaying the individual to provide a virtual attendant at the remote location, at least a second portion of the data being transferred from the call center to the kiosk and displayed on the display; and
at least one output for dispensing funds from the kiosk if the transaction is successful.

11. The kiosk of claim 10 further comprising at least one camera.

12. The kiosk of claim 10 wherein the at least one input device includes a card reader.

13. The kiosk of claim 12 further comprising a phone.

14. The kiosk of claim 10 wherein the at least one transaction includes a payday loan.

15. The kiosk of claim 14 wherein the first portion of the data includes an unsigned loan application.

16. The kiosk of claim 14 wherein the second portion of the data includes a signature of the customer.

17. The kiosk of claim 10 wherein the request further includes identification data for the customer and a selection of the at least one financial transaction.

18. The kiosk of claim 10 wherein the output further includes a card output, the card being loading a card with an amount corresponding to the funds, the card including at least one of a signature-based card and a personal identification number-based card.

19. A call center for providing remote financial services, the call center residing at a location and comprising:
at least one input for a request for at least one financial transaction from a customer at a remote location, the remote location including a first camera for capturing a first plurality of images and a first display, the remote location being physically distinct from the location of the call center, the call center;
a second camera coupled with the input, the second camera for capturing a second plurality of images of an individual at the call center, the second plurality of images being transferred through the at least one input to the display of the remote location to provide a virtual attendant at the remote location for assisting the customer with the at least one financial transaction;
a second display for displaying the first plurality of images to the individual at the call center;
at least one processor for transferring data for the at least one financial transaction between the call center and the kiosk, at least a first portion of the data being transferred from the call center to the kiosk and displayed on the display for the kiosk, at least a second portion of the data being transferred from the kiosk to the call center and being displayed to the individual, the processor further for transmitting a request to dispense funds to the customer if the at least one financial transaction is successful.

20. A system for providing remote financial services comprising:
a kiosk including a first camera, a first display, at least a first processor, and at least one output, the kiosk residing at a remote location and for receiving a request for at least one financial transaction from a customer, the first camera for capturing a first plurality of images a the remote location, the at least one output for dispensing funds from the kiosk if the transaction is successful;
a call center connected with the kiosk, the call center at a location physically distinct from the remote location of the kiosk, the call center including a second camera, at least a second processor, and a second display, the second camera for capturing a second plurality of images of an individual at the call center, the second plurality of images being transferred to the first display of the remote location to provide a virtual attendant at the remote location for assisting the customer with the at least one financial transaction, the second display for receiving and displaying the first plurality of images, data for the at least one financial transaction being transferred between the call center and the kiosk, at least a first portion of the data being transferred from the call center to the kiosk and displayed on the first display, at least a second portion of the data being transferred from the kiosk to the call center and being displayed on the second display.

21. The system of claim 20 wherein the at least one transaction includes a payday loan.

22. The system of claim 21 wherein the first portion of the data includes an unsigned loan application.

23. The system of claim 22 wherein the second portion of the data includes a signature of the customer.

24. The kiosk of claim 20 wherein the request further includes identification data for the customer and a selection of the at least one financial transaction.

25. The kiosk of claim 20 wherein the at least one output further includes a card output, the card being loading a card with an amount corresponding to the funds, the card including at least one of a signature-based card and a personal identification number-based card.
